(19) United States
(12) Patent Application Publication
(10) Pub. No.: US 2026/0224996 A1
(43) Pub. Date: Aug. 6, 2026

(54) VIDEO SWITCHING GAMEPAD AND CIRCUIT THEREOF

(71) Applicant: Shenzhen Yuyuanxin Electronic Technology Co., Ltd, Shenzhen (CN)

(72) Inventor: Haitao Cheng, Shenzhen (CN)

(21) Appl. No.: 19/576,559

(22) Filed: Mar. 24, 2026

Related U.S. Application Data
(62) Division of application No. 18/628,685, filed on Apr. 6, 2024.

(30) Foreign Application Priority Data
Dec. 28, 2023 (CN) 202311829852.7

(51) Int. Cl. A63F 13/92; A63F 13/24

(52) U.S. Cl. CPC A63F 13/92; A63F 13/24

(57) ABSTRACT

The present disclosure discloses a video switching gamepad and a circuit thereof. The video switching gamepad includes a housing. The video switching gamepad further includes a video switching module which is arranged in the housing and can project, when a user plays a game, a picture displayed on a screen of a console to another screen for displaying, output USB data and freely switch the picture back to the screen of the console. The video switching gamepad of the present disclosure fills the blank that there is no plug and play protection controller for SWITCH series games, and also improves the user experience and the comfort of the user.

### TECHNICAL FIELD

The present disclosure relates to a gamepad, and in particular, to a video switching gamepad and a circuit thereof.

### BACKGROUND

With the continuous growth of the market of gaming consumers, there is an increasing demand for a plug and play gamepad. Currently, all the plug and play gamepads on the market neither support video switching nor support a HUB function. The above functions can only be achieved through an original console base. In the prior art, it is very inconvenient for the gamepad to achieve projection and output the HUB function through the base, and the base cannot be directly used as a gamepad to play games.

### SUMMARY

For the shortcomings in the prior art, the technical problems to be solved in the present disclosure are to provide a video switching gamepad and a circuit thereof. The purpose of designing the video switching gamepad is that the video switching gamepad can switch a screen of a SWITCH console to a large screen to play a game while a user plays the game, and can output a USB3.0-HUB function and also freely switch the large screen to the screen of the SWITCH console.

In order to solve the above technical problems, the present disclosure is achieved by the following solutions: A video switching gamepad of the present disclosure includes a housing, wherein a sliding chute that penetrates through an upper end and a lower end is arranged on a front surface of the housing; a tail end of the sliding chute is provided with a stop body; the stop body is provided with a charging interface which is configured to be connected to a console and directly faces a slide-in end of the sliding chute; the housing is further provided with two groups of control parts, and the two groups of control parts are arranged separately on a tabletop connected to two sides of the sliding chute; the video switching gamepad further includes a supporting mechanism arranged on a back surface of the housing; clamping structures are oppositely arranged on the two sides of the sliding chute; and the video switching gamepad further includes a video switching module which is arranged in the housing and is able to project, when a user plays a game, a picture displayed on a screen of the console to another screen for displaying, output USB data and freely switch the picture back to the screen of the console.

Further, a hole body for mounting the supporting mechanism is formed in a back surface of the housing; the supporting mechanism includes: an elastic sheet, one end of which is fixed inside the housing, wherein the elastic sheet is bent to form a raised V-shaped clamping strip; the V-shaped clamping strip directly faces the hole body; and a supporting plate, one end of which is rotatably mounted at the hole body, wherein a connecting end of the supporting plate to the hole body is provided with a clamping slot for clamping the V-shaped clamping strip.

Further, two ends of the hole body are provided with bayonets; and rotating shafts capable of being clamped into the bayonets are arranged on two sides of the connection end of the supporting plate to the hole body.

Further, a reinforcing rib is arranged at a position of the sliding chute connected to the stop body.

Further, the clamping structures include side holes arranged on opposite sides of the sliding chute and two clamping blocks respectively fixed at the two side holes.

Further, the clamping blocks are L-shaped structural plates; two buckling holes are arranged at a corner between a bottom plate and a vertical plate of each L-shaped structural plate; one end of the vertical plate is provided with a first limiting plate, and the other end is provided with a second limiting plate; the first limiting plate and the second limiting plate are clamped to the housing; two buckling plates extending into the two buckling holes are arranged at the side holes; one end of the vertical plate that is used for the console to slide in has a slope; and one end of the vertical plate away from the slope is provided with a convex strip capable of resisting against a side part of the console.

A circuit of a video switching gamepad of the present disclosure includes: a processor circuit; a quick charging circuit, connected to the processor circuit; a video switching circuit, connected to the processor circuit; and a USB output circuit, connected to the processor circuit.

Further, the processor circuit has an integrated chip U1 integrated with a Power Delivery (PD) quick charging control unit and a High-Definition Multimedia Interface (HDMI) data transmission unit; and the integrated chip U1 is electrically connected to the PD quick charging interface, a game console interface, an HDMI video output interface, and a USB-HUB switching circuit.

Further, the quick charging circuit includes a PD quick charging voltage detection circuit, a PD quick charging switch circuit, and a direct current voltage reduction circuit; the PD quick charging voltage detection circuit includes a resistor R30, a resistor R31, a resistor R32, and a resistor R33; a first end of the serially connected resistor R30 and resistor R31 is grounded, and a second end is connected to a circuit DOWN_VBUS; a circuit node between the resistor R30 and the resistor R31 is connected to pin 66 VBUS_MON_D of the integrated chip U1; a first end of the serially connected resistor R32 and resistor R33 is grounded, and a second end is connected to a circuit UP_VBUS; a circuit node between the resistor R32 and the resistor R33 is connected to pin 67 VBUS_MON_U of the integrated chip U1; the PD quick charging switch circuit includes a P-channel Metal Oxide Semiconductor (P-MOS) transistor Q6, a P-MOS transistor Q7, a resistor R14, a resistor R10, a computer R9, a resistor R13, a resistor R15, a resistor R16, a resistor R5, a resistor R17, a resistor R18, a resistor R19, an N-channel Metal Oxide Semiconductor (N-MOS) transistor Q1, an N-MOS transistor Q4, an N-MOS transistor Q5, and an N-MOS transistor Q2; a source S of the P-MOS transistor Q6 and a source S of the P-MOS transistor Q7 are connected to each other; the resistor R10 is connected between the source S and a gate G of the P-MOS transistor Q6; the gate G of the P-MOS transistor Q6 is connected to a first end of the resistor R15; a second end of the resistor R15 is connected to a drain D of the N-MOS transistor Q4; a source S of the N-MOS transistor Q4 is grounded, and a gate G of the N-MOS transistor Q4 is connected to a first end of the resistor R17 and pin 58 DOWN_VBUS_EN of the integrated chip U1; a second end of the resistor R17 is grounded; a drain D of the P-MOS transistor Q6 is connected to the circuit DOWN_VBUS and a first end of resistor R14; a second end of the resistor R14 is connected to a drain D of the N-MOS transistor Q1; a source S of the N-MOS transistor Q1 is grounded; a gate G of the N-MOS transistor Q1 is connected to pin59 DOWN_VBUS_DIS of the integrated chip U1 and a first end of the resistor R5; a second end of the resistor R5 is grounded; the resistor R9 is connected between the source S and a gate G of the P-MOS transistor Q7; the gate G of the P-MOS transistor Q7 is connected to a first end of the resistor R16; a second end of the resistor R16 is connected to a drain D of the N-MOS transistor Q5; a source S of the N-MOS transistor Q5 is grounded, and a gate G of the N-MOS transistor Q5 is connected to a first end of the resistor R18 and pin 60 UP_VBUS_EN of the integrated chip U1; a second end of the resistor R18 is grounded; a drain D of the P-MOS transistor Q7 is connected to the circuit UP_VBUS and a first end of resistor R13; a second end of the resistor R13 is connected to a drain D of the N-MOS transistor Q2; a source S of the N-MOS transistor Q2 is grounded; a gate G of the N-MOS transistor Q2 is connected to pin 61 UP_VBUS_DIS of the integrated chip U1 and a first end of the resistor R19; a second end of the resistor R19 is grounded; the direct current voltage reduction circuit includes a voltage reduction chip U7, a capacitor C22, a capacitor C17, an inductor L3, a voltage regulator diode D2, a resistor R27, a resistor R28, a capacitor C18, a capacitor C16, and a capacitor C3; pin 2 IN of the voltage reduction chip U7 is connected to the source S of the P-MOS transistor Q6, a first end of the capacitor C22, and a first end of the capacitor C17; a second end of the capacitor C22 is grounded, and a second end of the capacitor C17 is grounded; pin 4 GND of the voltage reduction chip U7 is grounded; pin 3 SW of the voltage reduction chip U7 is respectively connected to a first end of the inductor L3 and a negative electrode of the voltage regulator diode D2; a positive electrode of the voltage regulator diode D2 is grounded; a second end of the inductor L3 is respectively connected to a first end of the resistor R27, a first end of the capacitor C18, a first end of the capacitor C16, and a first end of the capacitor C3; a second end of the resistor R27 is connected to pin 5 FB of the voltage reduction chip U7 and a first end of the resistor R28; a second end of the resistor R28 is grounded; a second end of the capacitor C18, a second end of the capacitor C16, and a second end of the capacitor C3 are respectively grounded; and the inductor L3 outputs BUS_5V to the circuit.

Further, the USB-HUB switching circuit includes a USB-HUB switching chip U6 and a USB3.0 interface; pin 2 GND and pin 3 GND1 of the USB-HUB switching chip U6 are respectively grounded, and pin 4 V1.8 of the USB-HUB switching chip U6 is connected to a first end of the capacitor C45, and a second end of the capacitor C45 is grounded; pin 5 VDD of the USB-HUB switching chip U6 is connected to the capacitor C46 and the circuit BUS_5V; the other end of the capacitor C46 is grounded; pin 6 DM and pin 7 DP of the USB-HUB switching chip U6 are correspondingly connected to pin 12 DM0 and pin 11 DP0 of the game console interface; pin 9 DP4 and pin 10 DM4 of the USB-HUB switching chip U6 are correspondingly correspond to pin 3 D+ and pin 2 D- of the USB3.0 interface; and pin 11 DP3 and pin 12 DM3 of the USB-HUB switching chip U6 are correspondingly connected to pin 4 and pin 3 of an interface CN5.

Compared with the prior art, the present disclosure has the following beneficial effects: The video switching gamepad of the present disclosure can achieve the purpose of switching a screen of a SWITCH console to a large screen to play a game while the user plays the game, and can output a USB3.0-HUB function and also freely switch the large screen to the screen of the SWITCH console. The video switching gamepad of the present disclosure fills the blank that there is no plug and play protection controller for SWITCH series games, and also improves the user experience and the comfort of the user.

### BRIEF DESCRIPTION OF THE DRAWINGS

FIG. 1 is a three-dimensional diagram of a video switching gamepad according to the present disclosure.

FIG. 2 is a structural diagram of a supporting plate according to the present disclosure.

FIG. 3 is a structural diagram of mounting of an elastic sheet according to the present disclosure.

FIG. 4 is a structural diagram of a back surface of a video switching gamepad according to the present disclosure.

FIG. 5 is a structural diagram of a clamping block according to the present disclosure.

FIG. 6 is a structural diagram of limitation of a sliding chute according to the present disclosure.

FIG. 7 is a schematic block diagram of a circuit according to the present disclosure.

FIG. 8 is a diagram of a processor circuit according to the present disclosure.

FIG. 9 is a circuit diagram of a PD quick charging interface according to the present disclosure.

FIG. 10 is a circuit diagram of a game console interface according to the present disclosure.

FIG. 11 is a diagram of a PD quick charging switch circuit according to the present disclosure.

FIG. 12 is a diagram of a PD quick charging voltage detection circuit according to the present disclosure.

FIG. 13 is a diagram of a direct current voltage reduction circuit according to the present disclosure.

FIG. 14 to FIG. 15 is a diagram of a USB-HUB switching circuit according to the present disclosure.

FIG. 16 is a circuit diagram of an HDMI video output interface according to the present disclosure.

FIG. 17 is a diagram of a video picture switching button circuit according to the present disclosure.

FIG. 18 is a diagram of an indicator lamp circuit according to the present disclosure.

FIG. 19 is a diagram of a HUB to video signal transmission circuit according to the present disclosure.

Reference numerals in the accompanying drawings: 1: housing; 2: sliding chute; 3: universal button for gamepad; 4: control part; 5: charging interface; 6: stop body; 7: reinforcing rib; 8: supporting mechanism; 9: rotating shaft; 10: clamping sot; 11: elastic sheet; 12: limiting convex plate; 13: convex strip; 14: clamping block; 15: slope; 16: buckling hole; 17: first limiting plate; 18: second limiting plate; 19: video switching button; 20: left and right back button; 101: processor circuit; 102: PD quick charging interface; 103: game console interface; 104: PD quick charging switch circuit; 105: PD quick charging voltage detection circuit; 106: direct current voltage reduction circuit; 107: USB-HUB switching circuit, 109: HDMI video output interface; 110: video picture switching button circuit; and 111: indicator lamp circuit.

### DETAILED DESCRIPTION OF THE EMBODIMENTS

The technical solutions in the embodiments of the present disclosure will be clearly and completely described below in conjunction with the accompanying drawings in the embodiments of the present disclosure, so that the advantages and features of the present disclosure can be more easily understood by those skilled in the art, and thus the protection scope of the present disclosure can be more clearly defined. In addition, the technical features involved in different implementations of the present disclosure described below can be combined with each other as long as they do not conflict with each other.

Embodiment 1: A specific structure of the present disclosure is as follows:

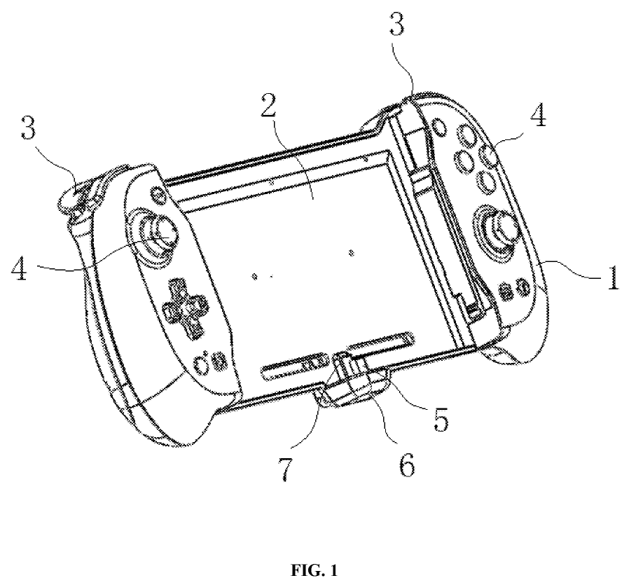

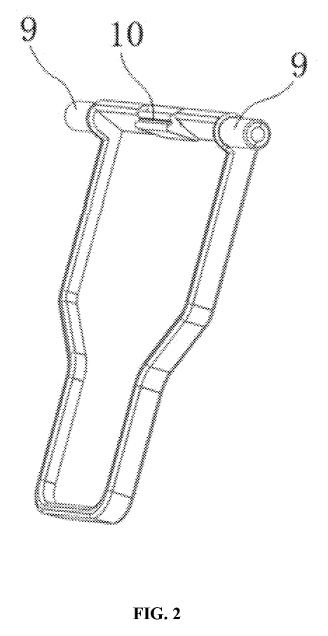

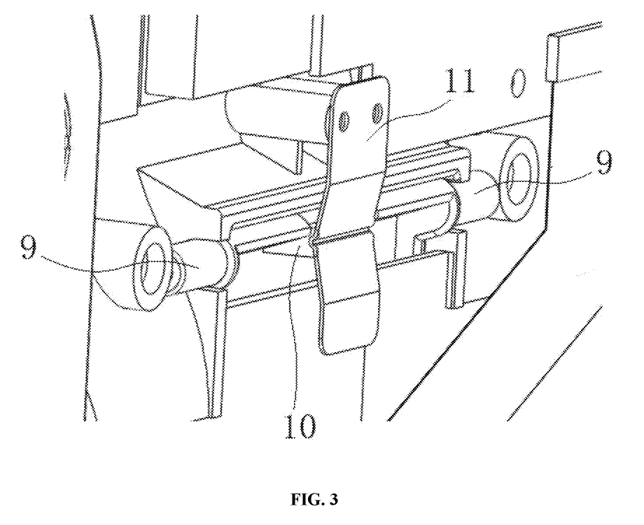

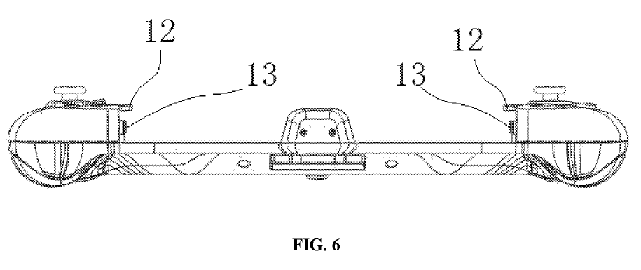

Referring to FIG. 1 to FIG. 6, a video switching gamepad of the present disclosure includes a housing 1, wherein a sliding chute 2 that penetrates through an upper end and a lower end is arranged on a front surface of the housing 1; a tail end of the sliding chute 2 is provided with a stop body 6; the stop body 6 is provided with a charging interface 5 which is configured to be connected to a console and directly faces a slide-in end of the sliding chute 2; the charging interface 5 adopts a Type-c charging interface; limiting convex plates 12 protruding outwards are arranged at upper edges of two side surfaces of the sliding chute 2; after the console slides into the sliding chute 2, edges of two sides of the console are limited by the two limiting convex plates 12 to form an anti-separation structure; the housing 1 is further provided with two groups of control parts 4, and the two groups of control parts 4 are arranged separately on a tabletop connected to two sides of the sliding chute 2; the control parts 4 are provided with several game control buttons and direction control buttons; the video switching gamepad further includes a supporting mechanism 8 arranged on a back surface of the housing 1; one end of the supporting mechanism 8 is rotatable; clamping structures are oppositely arranged on the two sides of the sliding chute 2; the clamping structures are configured to clamp the console; and the video switching gamepad further includes a video switching module which is arranged in the housing 1 and is able to project, when a user plays a game, a picture displayed on a screen of the console to another screen for displaying, output USB data and freely switch the picture back to the screen of the console.

In a preferred technical solution of this embodiment, a hole body for mounting the supporting mechanism 8 is formed in a back surface of the housing 1.

The supporting mechanism 8 includes: an elastic sheet 11, one end of which is fixed inside the housing 1, wherein the elastic sheet 11 is bent to form a raised V-shaped clamping strip; the V-shaped clamping strip directly faces the hole body; the elastic sheet 11 is a metal elastic sheet or a plastic elastic sheet, one end of which is fixed in the housing 1 through a screw; and a supporting plate, one end of which is rotatably mounted at the hole body, as shown in FIG. 3, wherein a connecting end of the supporting plate to the hole body is provided with a clamping slot 10 for clamping the V-shaped clamping strip.

In a preferred technical solution of this embodiment, two ends of the hole body are provided with bayonets; and rotating shafts 9 capable of being clamped into the bayonets are arranged on two sides of the connection end of the supporting plate to the hole body. After the rotating shafts 9 are clamped into the bayonets, the supporting plate can rotate.

In a preferred technical solution of this embodiment, a reinforcing rib 7 is arranged at a position of the sliding chute 2 connected to the stop body 6. The reinforcing rib 7 is used for improving the connection strength of the stop body 6.

In a preferred technical solution of this embodiment, the clamping structures include side holes arranged on opposite sides of the sliding chute 2 and two clamping blocks 14 respectively fixed at the two side holes.

In a preferred technical solution of this embodiment, the clamping blocks 14 are L-shaped structural plates; two buckling holes 16 are arranged at a corner between a bottom plate and a vertical plate of each L-shaped structural plate; one end of the vertical plate is provided with a first limiting plate 17, and the other end is provided with a second limiting plate 18; the clamping blocks 14 are non-fixed structures; after the console slides into the sliding chute 2, the first limiting plate 17 and the second limiting plate 18 clamp the side edges of the console; the first limiting plate 17 and the second limiting plate 18 are clamped to the housing 1; two buckling plates extending into the two buckling holes 16 are arranged at the side holes; one end of the vertical plate that is used for the console to slide in has a slope 15; the slope 15 is used for enabling the console to smoothly slide into the sliding chute 2; and one end of the vertical plate away from the slope 15 is provided with a convex strip 13 capable of resisting against a side part of the console. The convex strip 13 is in a direction perpendicular to a bottom surface of the sliding chute 2, and the console is clamped mainly by the convex strip 13.

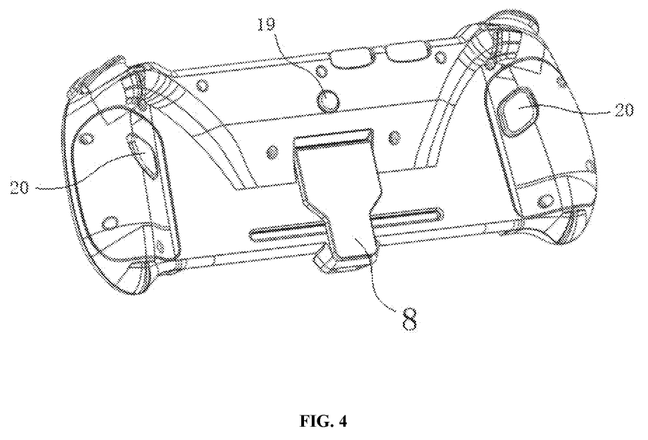

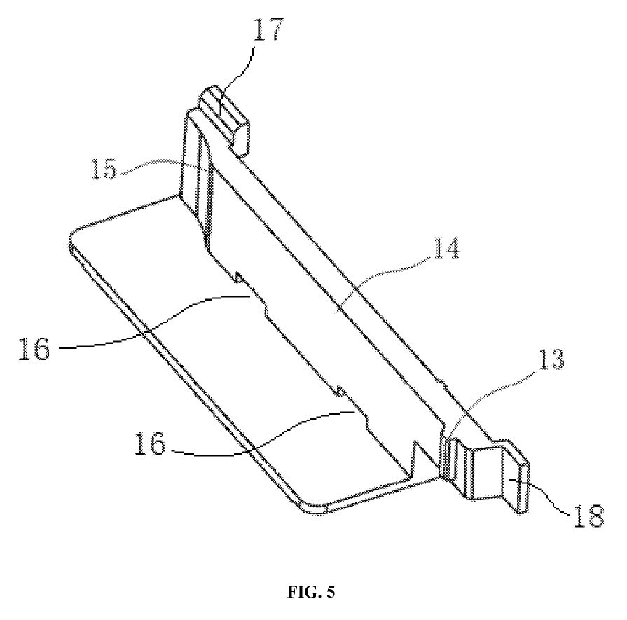

As shown in FIG. 4, a video switching button 19 and left and right back buttons 20 are arranged on a back surface of the video switching gamepad of the present disclosure. A game clamping slot and a universal button 3 for gamepad are further arranged on the housing of the video switching gamepad of the present disclosure.

### Embodiment 2:

A circuit of a video switching gamepad includes: a processor circuit 101; a quick charging circuit, connected to the processor circuit 101; a video switching circuit, connected to the processor circuit 101; and a USB output circuit, connected to the processor circuit 101.

In a preferred technical solution of this embodiment, the processor circuit 101 has an integrated chip U1 integrated with a PD quick charging control unit and an HDMI data transmission unit; and the integrated chip U1 is electrically connected to the PD quick charging interface 102, a game console interface 103, an HDMI video output interface 109, and a USB-HUB switching circuit 107.

In a preferred technical solution of this embodiment, the quick charging circuit includes a PD quick charging voltage detection circuit 105, a PD quick charging switch circuit 104, and a direct current voltage reduction circuit 106; the PD quick charging voltage detection circuit 105 includes a resistor R30, a resistor R31, a resistor R32, and a resistor R33; a first end of the serially connected resistor R30 and resistor R31 is grounded, and a second end is connected to a circuit DOWN_VBUS; a circuit node between the resistor R30 and the resistor R31 is connected to pin 66 VBUS_MON_D of the integrated chip U1; a first end of the serially connected resistor R32 and resistor R33 is grounded, and a second end is connected to a circuit UP_VBUS; a circuit node between the resistor R32 and the resistor R33 is connected to pin 67 VBUS_MON_U of the integrated chip U1; the PD quick charging switch circuit 104 includes a P-MOS transistor Q6, a P-MOS transistor Q7, a resistor R14, a resistor R10, a computer R9, a resistor R13, a resistor R15, a resistor R16, a resistor R5, a resistor R17, a resistor R18, a resistor R19, an N-MOS transistor Q1, an N-MOS transistor Q4, an N-MOS transistor Q5, and an N-MOS transistor Q2; a source S of the P-MOS transistor Q6 and a source S of the P-MOS transistor Q7 are connected to each other; the resistor R10 is connected between the source S and a gate G of the P-MOS transistor Q6; the gate G of the P-MOS transistor Q6 is connected to a first end of the resistor R15; a second end of the resistor R15 is connected to a drain D of the N-MOS transistor Q4; a source S of the N-MOS transistor Q4 is grounded, and a gate G of the N-MOS transistor Q4 is connected to a first end of the resistor R17 and pin 58 DOWN_VBUS_EN of the integrated chip U1; a second end of the resistor R17 is grounded; a drain D of the P-MOS transistor Q6 is connected to the circuit DOWN_VBUS and a first end of resistor R14; a second end of the resistor R14 is connected to a drain D of the N-MOS transistor Q1; a source S of the N-MOS transistor Q1 is grounded; a gate G of the N-MOS transistor Q1 is connected to pin59 DOWN_VBUS_DIS of the integrated chip U1 and a first end of the resistor R5; a second end of the resistor R5 is grounded; the resistor R9 is connected between the source S and a gate G of the P-MOS transistor Q7; the gate G of the P-MOS transistor Q7 is connected to a first end of the resistor R16; a second end of the resistor R16 is connected to a drain D of the N-MOS transistor Q5; a source S of the N-MOS transistor Q5 is grounded, and a gate G of the N-MOS transistor Q5 is connected to a first end of the resistor R18 and pin 60 UP_VBUS_EN of the integrated chip U1; a second end of the resistor R18 is grounded; a drain D of the P-MOS transistor Q7 is connected to the circuit UP_VBUS and a first end of resistor R13; a second end of the resistor R13 is connected to a drain D of the N-MOS transistor Q2; a source S of the N-MOS transistor Q2 is grounded; a gate G of the N-MOS transistor Q2 is connected to pin 61 UP_VBUS_DIS of the integrated chip U1 and a first end of the resistor R19; a second end of the resistor R19 is grounded; the direct current voltage reduction circuit 106 includes a voltage reduction chip U7, a capacitor C22, a capacitor C17, an inductor L3, a voltage regulator diode D2, a resistor R27, a resistor R28, a capacitor C18, a capacitor C16, and a capacitor C3; pin 2 IN of the voltage reduction chip U7 is connected to the source S of the P-MOS transistor Q6, a first end of the capacitor C22, and a first end of the capacitor C17; a second end of the capacitor C22 is grounded, and a second end of the capacitor C17 is grounded; pin 4 GND of the voltage reduction chip U7 is grounded; pin 3 SW of the voltage reduction chip U7 is respectively connected to a first end of the inductor L3 and a negative electrode of the voltage regulator diode D2; a positive electrode of the voltage regulator diode D2 is grounded; a second end of the inductor L3 is respectively connected to a first end of the resistor R27, a first end of the capacitor C18, a first end of the capacitor C16, and a first end of the capacitor C3; a second end of the resistor R27 is connected to pin 5 FB of the voltage reduction chip U7 and a first end of the resistor R28; a second end of the resistor R28 is grounded; a second end of the capacitor C18, a second end of the capacitor C16, and a second end of the capacitor C3 are respectively grounded; and the inductor L3 outputs BUS_5V to the circuit.

In a preferred technical solution of this embodiment, the USB-HUB switching circuit 107 includes a USB-HUB switching chip U6 and a USB3.0 interface; pin 2 GND and pin 3 GND1 of the USB-HUB switching chip U6 are respectively grounded, and pin 4 V1.8 of the USB-HUB switching chip U6 is connected to a first end of the capacitor C45, and a second end of the capacitor C45 is grounded; pin 5 VDD of the USB-HUB switching chip U6 is connected to the capacitor C46 and the circuit BUS_5V; the other end of the capacitor C46 is grounded; pin 6 DM and pin 7 DP of the USB-HUB switching chip U6 are correspondingly connected to pin 12 DM0 and pin 11 DP0 of the game console interface 103; pin 9 DP4 and pin 10 DM4 of the USB-HUB switching chip U6 are correspondingly correspond to pin 3 D+ and pin 2 D- of the USB3.0 interface; and pin 11 DP3 and pin 12 DM3 of the USB-HUB switching chip U6 are correspondingly connected to pin 4 and pin 3 of an interface CN5.

### Embodiment 3:

A specific working principle of the circuit of the present disclosure is as follows:

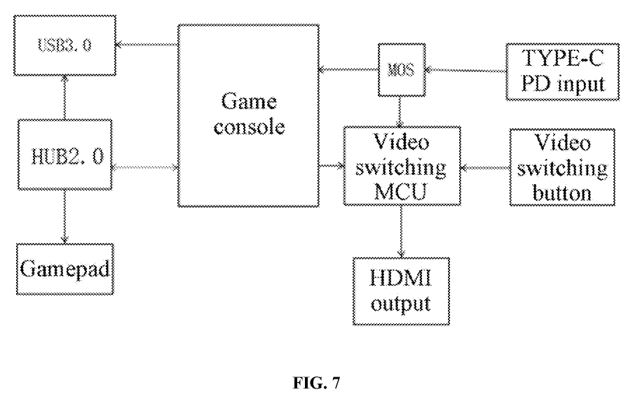

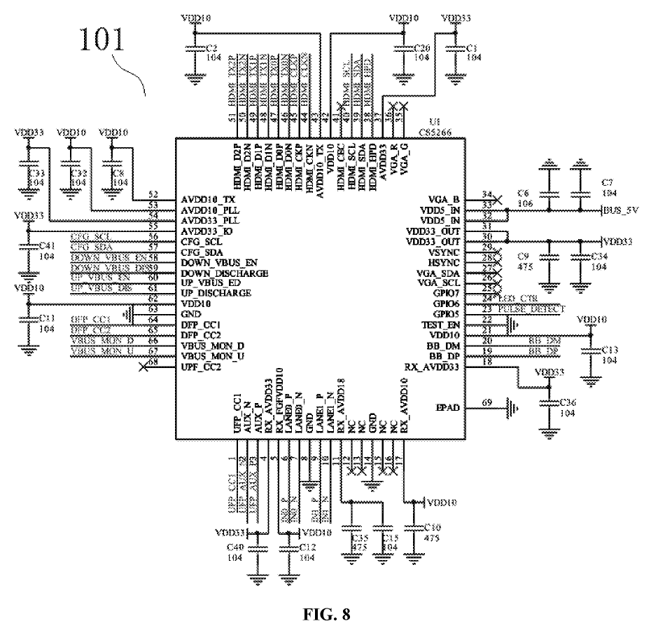

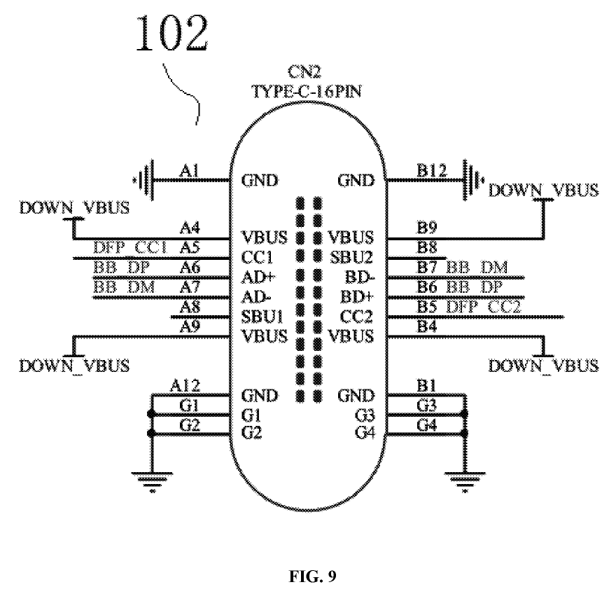

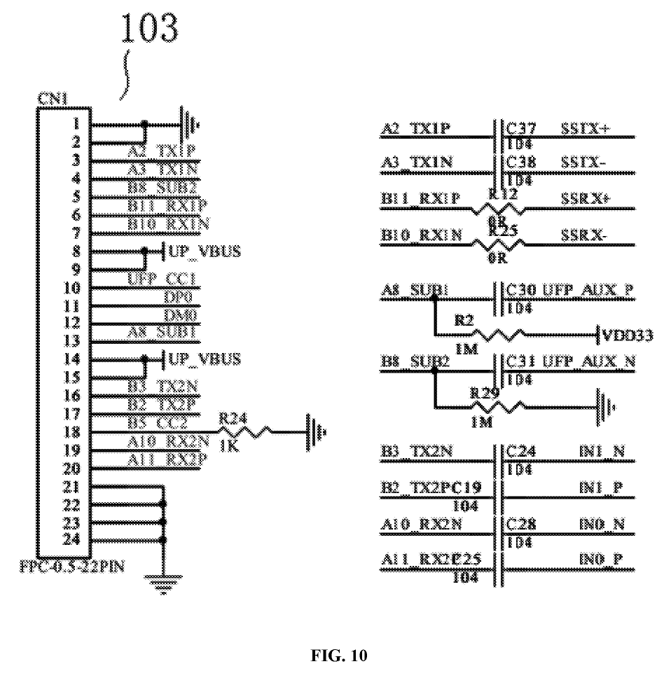

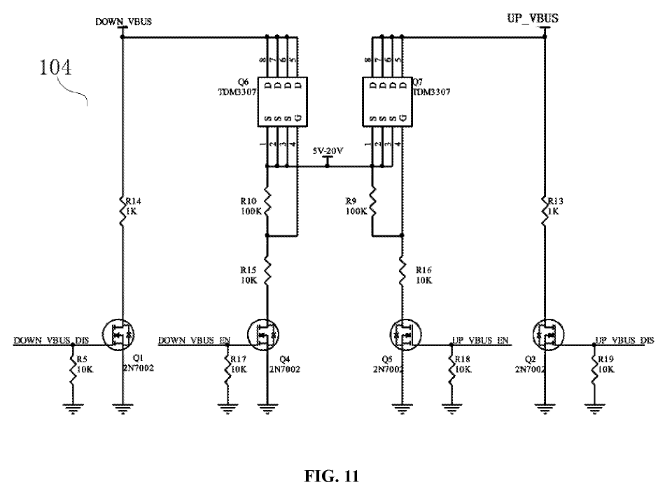

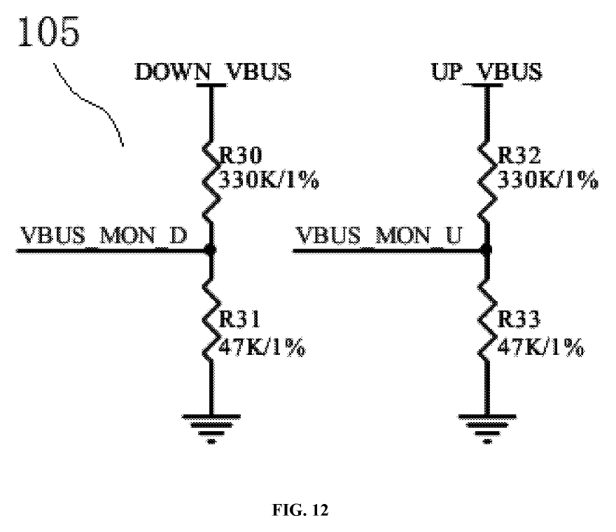

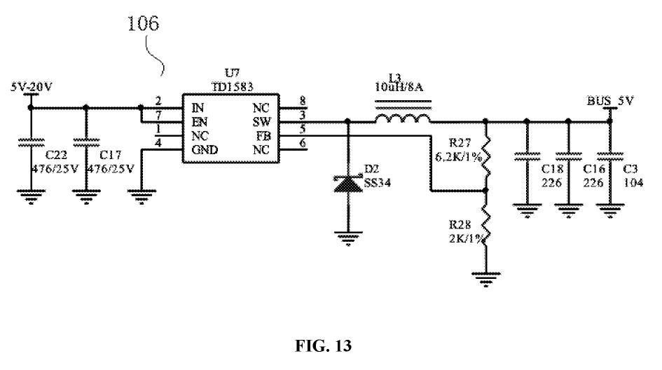

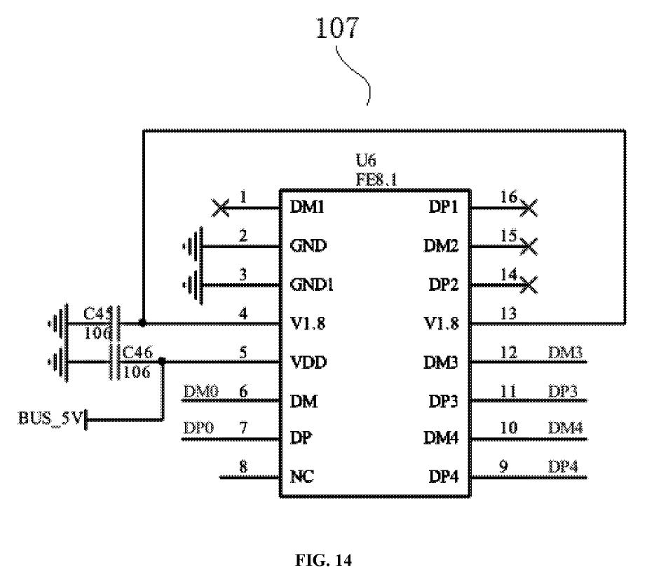

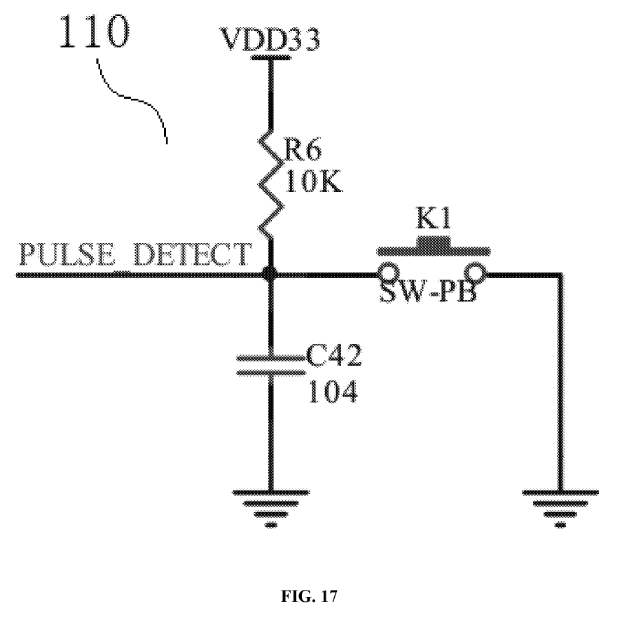

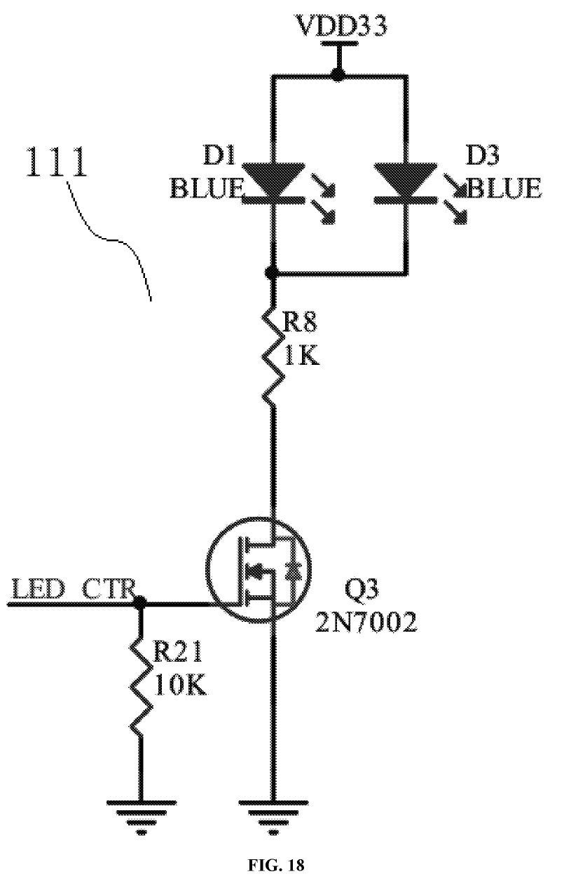

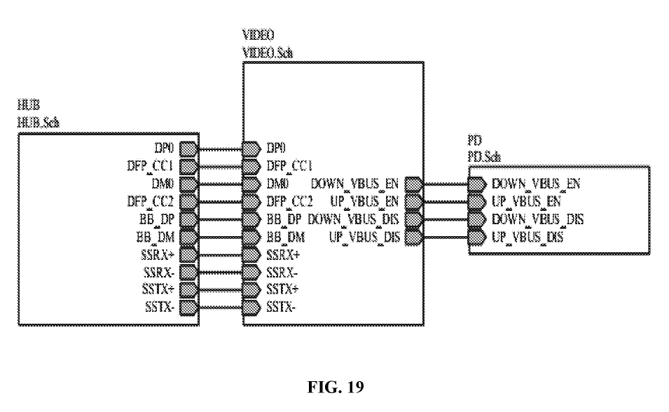

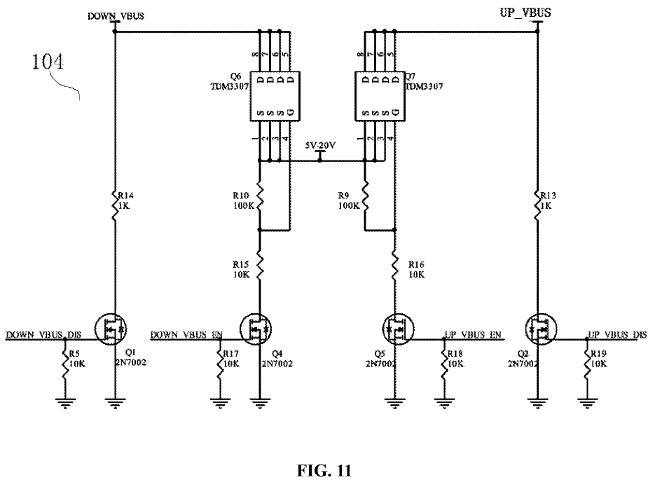

I. As shown in FIG. 7 to FIG. 19, the principle of the quick charging circuit of the present disclosure is as follows:

The console uses a SWITCH game console. When a switch power adapter (an alternating current input is 100-240 V, a direct current output is 5 V/1.5 A or 15 V/2.6 A) is plugged into the PD quick charging interface 102, there is a voltage of 5 V for starting by default. Meanwhile, the SWITCH game console is plugged into the gamepad of the present disclosure.

The voltage of 5 V flows to 5 V to 20 V from DOWN_VBUS of the PD quick charging interface 102 via a body diode inside the P-MOS transistor Q6, and a voltage 5V BUS_5V is obtained via the direct current voltage reduction circuit of the voltage reduction chip U7, so that the integrated chip U1 is electrified to start to work. The voltage reduction chip U7 is TD1583, and the integrated chip U1 is CS5266.

One side of the integrated chip U1 performs quick charging (QC) protocol communication with the game console through a voltage configuration signal UFP_CC1 of the game console interface 103, and the other side performs QC protocol communication with a power adapter thorough voltage configuration signals DFP_CC1 and DFP_CC2 of the PD quick charging interface 102, so that the game console and the power adapter achieves protocol handshaking, that is, the power adapter knows that the game console supports charging at what voltage and what current, thus starting a quick charging mode.

The integrated chip U1 adjusts voltages of the signals DFP_CC1 and DFP_CC2 of the PD quick charging interface 102, and the power adapter provides an output of 15 V/2.6 A. The voltage of 15 V comes out from DOWN_VBUS of the PD quick charging interface 102. The integrated chip U1 sends a high-level signal DOWN_VBUS_EN to the N-MOS transistor Q4. A working condition for turning on the N-MOS transistor Q4 is that a voltage of the gate G of the N-MOS transistor Q4 is greater than a voltage of the source S of the N-MOS transistor Q4. As the gate G of the N-MOS transistor Q4 is at a high level, which is greater than a grounding voltage of 0 V of the source S of the N-MOS transistor Q4, the drain D of the N-MOS transistor Q4 and the source S of the N-MOS transistor Q4 are turned on, and the voltages of the drain D and source S of the N-MOS transistor Q4 are consistent, both of which are 0 V. BUS_5V is shared by the resistor R10 and the resistor R15, so that a voltage of G (the gate) of the P-MOS transistor Q6 is 5V×10K/(10K+100K)=0.45 V. A working condition for turning on the P-MOS transistor Q6 is that a voltage of the source S of the P-MOS transistor Q6 is greater than a voltage of the gate G of the P-MOS transistor Q6. As the voltage of 5V to 20 V of the source S of the P-MOS transistor Q6 is greater than the voltage of 0.45 V of the gate G of the P-MOS transistor Q6, so that the source S of the P-MOS transistor Q6 and the drain D of the P-MOS transistor Q6 are completely turned on. In this case, the quick charging voltage of 15 V flows from DOWN_VBUS to 5 V to 20 V.

The integrated chip U1 sends a high-level signal UP_VBUS_EN to the N-MOS transistor Q5. A working condition for turning on the N-MOS transistor Q5 is that a voltage of the gate G of the N-MOS transistor Q5 is greater than a voltage of the source S of the N-MOS transistor Q5. As the gate G of the N-MOS transistor Q5 is at a high level, which is greater than a grounding voltage of 0 V of the source S of the N-MOS transistor Q5, the drain D of the N-MOS transistor Q5 and the source S of the N-MOS transistor Q5 are turned on, and the voltages of the drain D of the N-MOS transistor Q5 and the voltage of the source S of the N-MOS transistor Q5 are consistent, both of which are 0 V. BUS_5V is shared by the resistor R9 and the resistor R16, so that a voltage of the gate G of the P-MOS transistor Q7 is 5V×10K/(10K+100K)=0.45V. As the voltage of 5V to 20 V of S (the source) of the P-MOS transistor Q7 is greater than the voltage of 0.45 V of G (the gate) of the P-MOS transistor Q7, so that S (the source) of the P-MOS transistor Q7 and D (the drain) of the P-MOS transistor Q7 are completely turned on. 5 V to 20 V flows to the circuit UP_VBUS via the P-MOS transistor Q7. The voltage at the circuit UP_VBUS flows to the game console through the game console interface, which achieves the purpose of quick charging.

During this period, the integrated chip U1 detects the voltage signals VBUS_MON_D and VBUS_MON_U of the circuit DOWN_VBUS and the circuit UP_VBUS, so as to detect information such as whether the power adapter is plugged or unplugged and whether the game console is fully charged.

II. A principle of a USB 3.0 data output part is as follows:

The SWITCH game console is plugged into the gamepad, and power of the SWITCH game console is supplied to the circuit via UP_VBUS of the game console interface 103. Under normal circumstances, the voltage of 5 V is supplied by default.

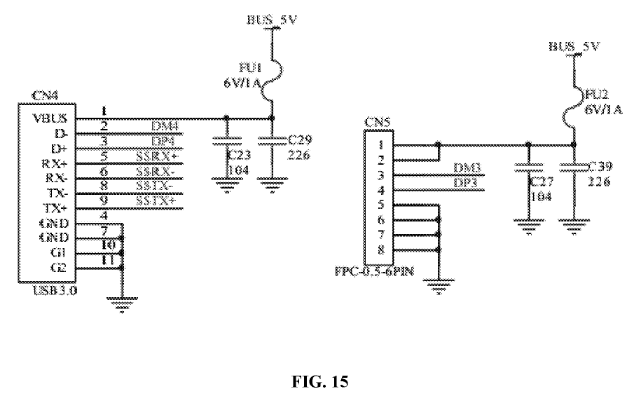

In terms of the power: UP_VBUS of the game console interface 103 flows to 5 V to 20 V via a body diode inside the P-MOS transistor Q7. As the diode has a voltage drop of 0.3 V, the voltage of 5 V to 20 V is equal to UP_VBUS-0.3 V=5 V-0.3 V=about 4.7 V. The voltage of BUS_5V is obtained via the direct current voltage reduction circuit of the voltage reduction chip U7, so that the voltage of BUS_5V is equal to 5 V to 20 V-0.3 V=4.7 V-0.3 V=about 4.4 V, which is greater than the minimum voltage of 4 V according to the USB3.0 standard requirement and is high enough to enable the USB3.0 interface (the left view of FIG. 15) to work normally. The USB3.0 interface is an interface CN4 in FIG. 15. BUS_5V of the USB3.0 interface is filtered by a resettable fuse FU1, a capacitor C23, and a capacitor C29, so as to supply stable direct current power to the interface CN4.

USB2.0 transmitted signal:

A USB2.0 transmitted signal of the SWITCH game console is led out to DP0 and DM0 of the game console interface 103, and the USB-HUB switching chip U6 divides a part of the USB2.0 transmitted signal to the interface CN4.

USB 3.0 transmitted signal:

A USB 3.0 transmitted signal of the SWITCH game console is led out to A2_TX1P, A3_TX1N, B11_RX1P, and B10_RX1N of the game console interface 103. A2_TX1P and A3_TX1N of the game console interface 103 is correspondingly coupled and filtered by a capacitor C37 and a capacitor C38. Clean signals are sent to the interface CN4. B11_RX1P and B10_RX1N of the game console interface 103 are sent to the interface CN4 via a resistor R12 and a resistor R25.

In this case, the interface CN4 can provide a support for equipment that meets USB3.0.

III. PD-to-HDMI video switching function

The PD-to-HDMI video switching circuit needs to be connected to an external PD quick charging power supply. When the PD quick charging interface CN2 is plugged into the power supply, the integrated chip U1 obtains power and starts to work.

A USB3.0 high-speed transmitted signal of the SWITCH game console is led out to B3_TX2N, B2_TX2P, A10_RX2N, and A11_RX2P of the game console interface 103, and B3_TX2N, B2_TX2P, A10_RX2N, and A11_RX2P are correspondingly coupled and filtered via a capacitor C24, a capacitor C19, a capacitor C28, and a capacitor C25 to obtain clean output signals IN1_N, IN1_P, IN0_N, and IN0_P. The clean output signals IN1_N, IN1_P, IN0_N, and IN0_P are sent to the integrated chip U1 for processing and switching to obtain video signals.

An audio signal of the SWITCH game console is led out to B8_SUB2 and A8_SUB1 of the game console interface 103, and the B8_SUB2 and A8_SUB1 are coupled and filtered via a capacitor C31 and a capacitor C30 to obtain clean output signals UFP_AUX_N and UFP_AUX_P. The clean output signals UFP_AUX_N and UFP_AUX_P are sent to the integrated chip U1 for processing and switching to obtain the audio signal.

A high-speed transmitted signal and audio signal processed by the integrated chip U1 are converted into three pairs of audio and video combined anti-interference differential signals HDMI_TX2P, HDMI_TX2N, HDMI_TX1P, HDMI_TX1N, HDMI_TX0P, and HDMI_TX0N, and the chip integrates clock signals HDMI_CLKP and HDMI_CLKN for high-speed synchronization, signals HDMI_SCL and HDMI_SDA for mutual recognition of a display and an output device, and a signal HDMI_HPD for supporting hot plugging.

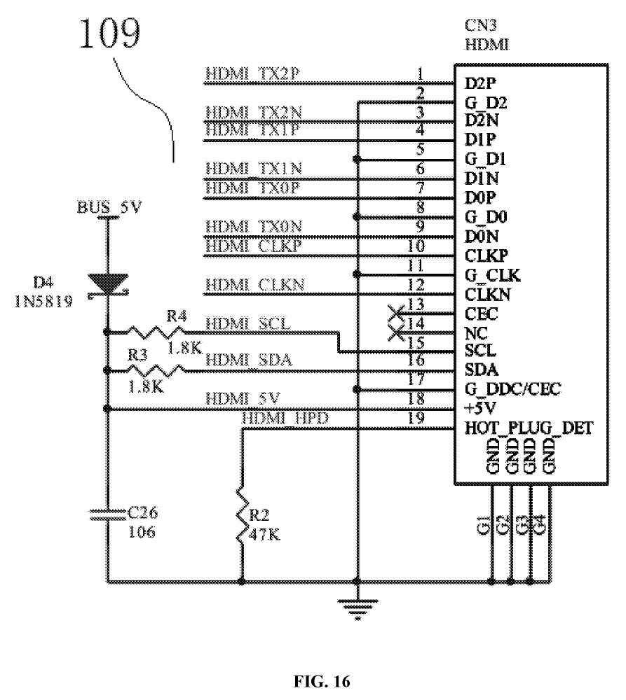

As shown in FIG. 16, the power is from BUS_5V converted by PD quick charging interface CN2 and is filtered by a unidirectional characteristic of a Schottky diode D4 in the HDMI video output interface 109 and capacitance of the capacitor C26, so as to provide a stable power guarantee for video transmission of the HDMI video output interface 109.

Thus, an HDMI video is formed.

When an HDMI cable of an external TV, a protector, or another display device is plugged into the HDMI video output interface 109, the integrated chip U1 achieves automatic detection and recognition through a hot plug signal HDMI_HPD and device recognition signals HDMI_SCL and HDMI_SDA, and a picture of the Switch console will be automatically switched to high-definition HDMI after one to eight seconds and output to the display device. Furthermore, the integrated chip U1 sends a signal LED_CTR to the indicator lamp circuit 111, and a light emitting diode D1 and a light emitting diode D3 emit blue light. During this period, a switching button K1 in a video picture switching button circuit 110 is pressed, so that the integrated chip U1 receives a signal PULSE_DETECT. In this case, the video picture is switched to be displayed on the Switch console.

The display device and the Switch console can switch displayed pictures to each other, with predicted switching time of one to eight seconds.

The above describes only preferred implementations of the present disclosure and does not limit the patent scope of the present disclosure. Any equivalent structure or equivalent process transformation made using the specification and accompanying drawings of the present disclosure, or directly or indirectly applied in other related technical fields, are equally included in the scope of patent protection of the present disclosure.

What is claimed is:

1. A circuit of a video switching gamepad, comprising:
a processor circuit (101);
a quick charging circuit, connected to the processor circuit (101);
a video switching circuit, connected to the processor circuit (101); and
a USB output circuit, connected to the processor circuit (101).

2. The circuit according to claim 1, wherein the processor circuit (101) has an integrated chip U1 integrated with a Power Delivery (PD) quick charging control unit and a High-Definition Multimedia Interface (HDMI) data transmission unit; and the integrated chip U1 is electrically connected to the PD quick charging interface (102), a game console interface (103), an HDMI video output interface (109), and a USB-HUB switching circuit (107).

3. The circuit according to claim 2, wherein the quick charging circuit comprises a PD quick charging voltage detection circuit (105), a PD quick charging switch circuit (104), and a direct current voltage reduction circuit (106);
the PD quick charging voltage detection circuit (105) comprises a resistor R30, a resistor R31, a resistor R32, and a resistor R33; a first end of the serially connected resistor R30 and resistor R31 is grounded, and a second end is connected to a circuit DOWN_VBUS; a circuit node between the resistor R30 and the resistor R31 is connected to pin 66 VBUS_MON_D of the integrated chip U1; a first end of the serially connected resistor R32 and resistor R33 is grounded, and a second end is connected to a circuit UP_VBUS; a circuit node between the resistor R32 and the resistor R33 is connected to pin 67 VBUS_MON_U of the integrated chip U1;
the PD quick charging switch circuit (104) comprises a P-channel Metal Oxide Semiconductor (P-MOS) transistor Q6, a P-MOS transistor Q7, a resistor R14, a resistor R10, a computer R9, a resistor R13, a resistor R15, a resistor R16, a resistor R5, a resistor R17, a resistor R18, a resistor R19, an N-channel Metal Oxide Semiconductor (N-MOS) transistor Q1, an N-MOS transistor Q4, an N-MOS transistor Q5, and an N-MOS transistor Q2;
a source S of the P-MOS transistor Q6 and a source S of the P-MOS transistor Q7 are connected to each other;
the resistor R10 is connected between the source S and a gate G of the P-MOS transistor Q6; the gate G of the P-MOS transistor Q6 is connected to a first end of the resistor R15; a second end of the resistor R15 is connected to a drain D of the N-MOS transistor Q4; a source S of the N-MOS transistor Q4 is grounded, and a gate G of the N-MOS transistor Q4 is connected to a first end of the resistor R17 and pin 58 DOWN_VBUS_EN of the integrated chip U1; a second end of the resistor R17 is grounded;
a drain D of the P-MOS transistor Q6 is connected to the circuit DOWN_VBUS and a first end of resistor R14; a second end of the resistor R14 is connected to a drain D of the N-MOS transistor Q1; a source S of the N-MOS transistor Q1 is grounded; a gate G of the N-MOS transistor Q1 is connected to pin59 DOWN_VBUS_DIS of the integrated chip U1 and a first end of the resistor R5; a second end of the resistor R5 is grounded;
the resistor R9 is connected between the source S and a gate G of the P-MOS transistor Q7; the gate G of the P-MOS transistor Q7 is connected to a first end of the resistor R16; a second end of the resistor R16 is connected to a drain D of the N-MOS transistor Q5; a source S of the N-MOS transistor Q5 is grounded, and a gate G of the N-MOS transistor Q5 is connected to a first end of the resistor R18 and pin 60 UP_VBUS_EN of the integrated chip U1; a second end of the resistor R18 is grounded;
a drain D of the P-MOS transistor Q7 is connected to the circuit UP_VBUS and a first end of resistor R13; a second end of the resistor R13 is connected to a drain D of the N-MOS transistor Q2; a source S of the N-MOS transistor Q2 is grounded; a gate G of the N-MOS transistor Q2 is connected to pin 61 UP_VBUS_DIS of the integrated chip U1 and a first end of the resistor R19; a second end of the resistor R19 is grounded;
the direct current voltage reduction circuit (106) comprises a voltage reduction chip U7, a capacitor C22, a capacitor C17, an inductor L3, a voltage regulator diode D2, a resistor R27, a resistor R28, a capacitor C18, a capacitor C16, and a capacitor C3;
pin 2 IN of the voltage reduction chip U7 is connected to the source S of the P-MOS transistor Q6, a first end of the capacitor C22, and a first end of the capacitor C17; a second end of the capacitor C22 is grounded, and a second end of the capacitor C17 is grounded;
pin 4 GND of the voltage reduction chip U7 is grounded;
pin 3 SW of the voltage reduction chip U7 is respectively connected to a first end of the inductor L3 and a negative electrode of the voltage regulator diode D2; a positive electrode of the voltage regulator diode D2 is grounded; a second end of the inductor L3 is respectively connected to a first end of the resistor R27, a first end of the capacitor C18, a first end of the capacitor C16, and a first end of the capacitor C3; a second end of the resistor R27 is connected to pin 5 FB of the voltage reduction chip U7 and a first end of the resistor R28; a second end of the resistor R28 is grounded; a second end of the capacitor C18, a second end of the capacitor C16, and a second end of the capacitor C3 are respectively grounded; and
the inductor L3 outputs BUS_5V to the circuit.

4. The circuit according to claim 2, wherein the USB-HUB switching circuit (107) comprises a USB-HUB switching chip U6 and a USB3.0 interface; pin 2 GND and pin 3 GND1 of the USB-HUB switching chip U6 are respectively grounded, and pin 4 V1.8 of the USB-HUB switching chip U6 is connected to a first end of the capacitor C45, and a second end of the capacitor C45 is grounded; pin 5 VDD of the USB-HUB switching chip U6 is connected to the capacitor C46 and the circuit BUS_5V; the other end of the capacitor C46 is grounded;
pin 6 DM and pin 7 DP of the USB-HUB switching chip U6 are correspondingly connected to pin 12 DM0 and pin 11 DP0 of the game console interface (103);
pin 9 DP4 and pin 10 DM4 of the USB-HUB switching chip U6 are correspondingly correspond to pin 3 D+ and pin 2 D- of the USB3.0 interface; and
pin 11 DP3 and pin 12 DM3 of the USB-HUB switching chip U6 are correspondingly connected to pin 4 and pin 3 of an interface CN5.
